(19) United States
(12) Patent Application Publication
(10) Pub. No.: US 2009/0200486 A1
(43) Pub. Date: Aug. 13, 2009

(54) Quantum dot-DNA-metallic nanoparticle ensemble as fluorescent nanosensor system for multiplexed detection of heavy metals

(76) Inventors: Nianqiang Wu, Morgantown, WV (US); Xiaodong Shi, Morgantown, WV (US); Lawrence Hornak, Morgantown, WV (US)

Correspondence Address: WEST VIRGINIA UNIVERSITY RESEARCH CORPORATION, 886 CHESTNUT RIDGE ROAD, P.O. BOX 6224, MORGANTOWN, WV, 26506-6224, US

(21) Appl. No.: 12/378,350

(22) Filed: Feb. 13, 2009

Related U.S. Application Data
(60) Provisional application No. 61/065,554, filed on Feb. 13, 2008.

(51) Int. Cl. G01N 21/64; H05B 33/00

(52) U.S. Cl. 250/461.1; 250/484.2

(57) ABSTRACT

A first embodiment is a quantum dot-DNA-metallic ensemble that can be used as a fluorescent nanosensor for multiplexed detection of the presence and the quantity of one or more target ions in a single assay. In this design, DNA-functionalized multi-colored quantum dots are used as energy donors and god nanoparticles are used as energy acceptors. This design allows for flexibility and a selective binding of a target ion to oligonucleotides, drives the formation of DNA helixes, which bring a quantum dot and metallic nanoparticle into close proximity, leading to a fluorescence emission energy transfer. The energy transfer is detected and the presence and the quantity of the target ion can be confirmed.

### CROSS-REFERENCE TO RELATED APPLICATIONS

This application claims priority to U.S. Provisional Application No. 61/065,554 filed on Feb. 13, 2008.

### REFERENCE TO SEQUENCE LISTING, A TABLE, OR A COMPUTER PROGRAM LISTING COMPACT DISC APPENDIX

Not Applicable

### BRIEF DESCRIPTION OF THE SEVERAL VIEWS OF THE DRAWINGS

The following figures are not drawn to scale and are for illustrative purposes only.

FIG. 1 is a view of Thymine-Thymine base pair for Hg²⁺ binding.

FIG. 2 is a view of Hydroxypyridone base pair for Cu²⁺ binding.

FIG. 3 is a view of G-quartet for Pb²⁺ binding.

FIG. 4 is a view of the selective chemical binding between metal ions and DNA bases.

### DETAILED DESCRIPTION OF THE INVENTION

A first embodiment of a quantum dot-DNA-metallic nanoparticle ensemble can be a fluorescent nanosensor system for simultaneous detection of one or more heavy metals such as Hg, Cu and Pb in a single assay with high sensitivity, selectivity and reliability. In the fluorescent nanosensor system a quantum dot-DNA-metal ion-metallic nanoparticle ensemble capable of generating fluorescent (Föster) resonance energy transfer (FRET) can act as a heavy metal detecting biosensor due to changes in FRET. In this embodiment the fluorescent emission of quantum dots (QDs) is quenched by the close proximity of the QD with metallic nanoparticles (NPs) causing a change in energy and a method of heavy metal detection. The luminescence quenching of QDs by metallic nanoparticles was recently discovered and validated by others [1]. The nanoparticles may be any metallic particles one skilled in the art would recognize for use, such as one or more of Au, Pt, and Ag. In a further embodiment, single-stranded DNA molecules can act as molecular recognition probes for the heavy metals and one or more can be covalently attached to the QDs and the metallic NPs, respectively. When the targeted heavy metals are absent in the assay the two DNA single-strands cannot be hybridized due to the fact that the two DNA single-strands are non-complementary and therefore the QDs and NPs are not in close proximity. Once specific target heavy metal ions are present, however, the heavy metal ions are sandwiched between the two MRPs. The presence leads to the hybridization of the DNA strands. The hybrid results in the formation of double helix of DNA and thus brings the free-standing QDs and the metallic NPs to a shorter distance or as defined in this application as close proximity which is about 5 to about 10 nm. As a result, the emission intensity of QDs is reduced or quenched and this change can be observed by changes in FRET. A calibration curve plotting the emission intensity as a function of the concentration of the specific heavy metals in a certain range as a linear curve can quantify heavy metal amounts. The reduction in the emission intensity can be read and/or recorded with a handheld spectrofluorometer. The calibration curve allows a user to not only identify the presence but also quantify the concentration of specific heavy metals in a sample.

The QP-NP ensemble assay has significant advantages such as low background noise, enhanced sensitivity and the ability to label both the QD and NPs with multiple molecular recognition probes.
(i) The QD-NP optical assay eliminates the photo-bleaching problem that is usually associated with the organic dyes. Also, individual QDs are bright fluorophores due to their high quantum yield. The bright fluoropores enable the QD-NP assay to offer high sensitivity.
(ii) The proper design of the DNA sequence can be corroborated by controlled experiments to allow the specific detection of different metal ions. The specific detection enables the sensor to have high selectivity. Existing heavy metal sensors with either small molecules or proteins as molecular recognition probes have several drawbacks when compared to larger biological molecules during heavy metal detection. The large biological molecules, such as proteins and DNA, possess more precise binding sites as compared to a small molecule ion receptor. One significant advantage using large biological molecules in metal ion recognition is much greater selectivity and sensitivity over small organic cation receptors.
(iii) The use of DNA as a molecular recognition probe is more robust in a non-physiological solution than enzymes, proteins and live microbes that are typically used as molecular recognition probes in biosensors. Proteins are commonly used for selective target recognition of heavy metals. However, proteins are much more sensitive to the testing environment than DNA. Simple factors such as pH, temperature, and salt concentration will significantly influence the activity of protein-target bind. Therefore, a much stricter environment is required for protein which limits the application of the protein recognition system.
(iv) The design provides the capability of simultaneous and discriminative detection of several M²⁺ metal ions in one sample through tuning the optical emission of quantum dots at various wavelengths. The fluorescence emissions of the multi-color QDs can be excited with a single laser at a wavelength far from the emission wavelengths of all the QDs.

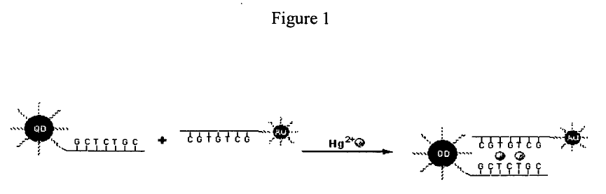

The first embodiment may also be described as a biosensor for the detection of one or more heavy metals. A single nanosensor assay can be created by adding a sufficient amount of single-stranded DNA functionalized QDs and NPs into a buffer solution. A sufficient amount of QDs and NPs can be a concentration of QD or metal NP can ranging from about 1 ppb (part per million) to about 1 g/L. A typical buffer solution can contain 3-(Nmorpholino)propanesulfonic acid (10 mM, pH 7.0), NaCl (25 mM), NaNO₃ (500 mM), and ethylenediaminetetraacetic acid (EDTA) (0.1 mM). However, other standard buffer solutions such as acetate buffer (pH 3), phosphate buffer (pH 6), phosphate buffer (pH 7.4) and carbonate buffer (pH 10.2) can also be used. During testing, a sufficient temperature for keeping the solution can be about 4 to about 30° C. The single nanosensor assay can be stored in at about 4° C. for up to 3 months without any noticeable loss of quality. The biosensor can be created if the energy transfer path is turned on by a metal binding event (FIGS. 1, 2, and 3). One or more oligonucleotide strands can be linked to quantum dots and metallic nanoparticles, respectively. When specific heavy metal ions, such as Hg²⁺, are present in the aqueous solution that contains the oligonucleotide-conjugated QDs and metallic NPs, then heavy metal ions selectively bind to the oligonucleotides driving the formation of DNA helixes. The quantum dot and metallic nanoparticles are brought into close proximity. This leads to the fluorescence resonance energy transfer from the QD to the NPs wherein the fluorescence emission of the QD is quenched by the NP. The selectivity of the nanosensor can be achieved by using DNA sequences specific for certain heavy metals. Thus an approach based on DNA/metal interactions is possible to be a general approach for selective detection of different metal ions.

An embodiment can utilize multicolored quantum dots (QDs) as the energy donors instead of the organic dyes. This allows more flexibility for multiplexed detection of several heavy metals in a single assay. Multiple colored QDs such as green (with emission maxima at around 535 nm), yellow (585 nm) and red (635 nm) can be employed to sense different heavy metals within a single assay. One way of changing colors is to use the CdSe/ZnS core-shell QDs. The emitted color of such QDs can be simply controlled by either the size of the CdSe core or the number of atomic layers of the ZnS shell. However, any color could be used and the present application is not limited to the use of any color/metal combination. Any optical semiconductor nanoparticle that can emit light in the range from 380 nm to 25 microns (that is, from visible light, near infrared light to infrared light) can be used in the present application. Also, other up-conversion or down-conversion inorganic nanoparticles that can emit light in the range from 380 nm to 25 microns can be used in the present applications.

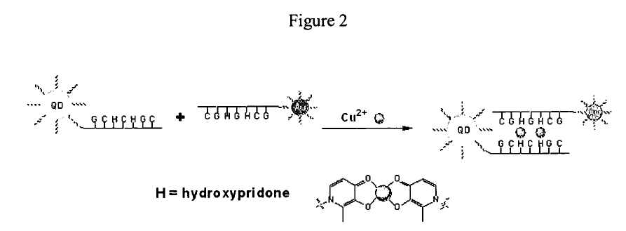

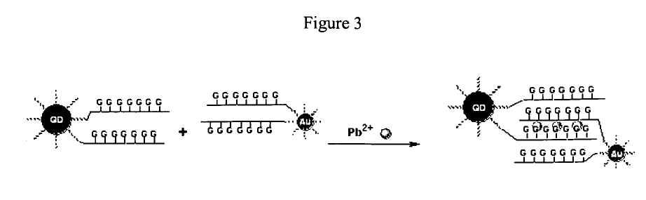

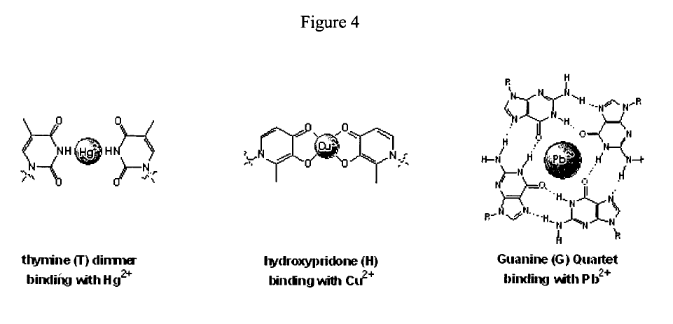

The selectivity toward the specific target heavy metal ions can be achieved by the use of DNA sequences with specific heavy metal binding characteristics bound to the QD and metallic NP. For example, the thymine-thymine mismatching in the DNA double helixes can selectively bind with Hg²⁺ (FIG. 1). The thymine enriched DNA can, with great selectivity for the Hg²⁺ ion, produce the double helical structures. Clear evidence has been reported in literature regarding the superior DNA binding with Hg²⁺ over many other transition metal ions in a compatible concentration [2]. Non-natural nucleobase hydroxypridone (H) can produce stable helixes by binding with Cu²⁺ (FIG. 2). It has been shown in the literature that Cu²⁺ cations efficiently stabilized the formation of duplex structure while interacting with hydropyridone modified DNA [3]. No other metal ions have shown this binding property with hydropyridone modified DNA. The G-rich DNA-conjugated QD/metallic NP biosystem can be a great binding sequence for Pb²⁺ during the formation of G-quartet quadruplexes (FIG. 3). Among most of the transitional metal cations, Pb²⁺ possesses the strongest binding with the guanine base by forming a G-quadruplex. The binding affinity between guanine and Pb²⁺ is much higher than the binding of the G-quartet with Na⁺ and K⁺. Therefore, a G-quadruplex approach in the selective binding of DNA with Pb²⁺ should be effectively detected by the QD-metallic NP assay. The chemical binding mechanism for these three metal ions is given in FIG. 4.

Any embodiment may use a single ultraviolet (UV) laser source to excite the multiple colored QDs at different emission wavelengths. The variation of the Hg²⁺, Cu²⁺ and Pb²⁺ ion concentrations can be distinguished by the color changes of the QDs. An example would be the attachment of a thymine-thymine mismatch to both a QD with emission around 535 nm and a metallic NP. If the Hg²⁺ ions are present in the solution, the emission intensity of green QDs will be reduced with increasing Hg²⁺ concentration.

An advantage of the QD-NP ensemble over the use of organic dyes as the donor-acceptor pairs in the FRET sensor is that multiple organic dye pairs would be required to differentiate the binding events among various metal ions in order to achieve the goal of simultaneous detection of multiple metal ions. To obtain efficient differentiated sensing among Hg²⁺, Cu²⁺ and Pb²⁺, it becomes both unlikely and impractical to find three organic dye pairs to sense the different ions without excitation/emission photo overlapping. Another advantage over the use of organic dyes is that the QD-metallic NP optical assay eliminates the photo-bleaching problem that is usually associated with the organic dyes.

The energy transfer efficiency, E, for an isolated single donor-acceptor pair is dependent on the interparticle distance, r, between the donor and the acceptor, which is quantitatively expressed by [4]:

$$E = \frac{{R}_{0}^{6}}{{R}_{0}^{6} + r} \qquad ( 1 )$$

The distance, R₀, at which energy transfer between the donor and the acceptor is 50% efficient is known as the Föster radius (typically less than 10 nm). The Föster radius is determined by several factors such as the molecular dipole, quantum yield, refractive index, and spectral overlap [4]. Clapp et a. have demonstrated that FRET in QD-protein-dye conjugates can occur by accurately controlling the donor-acceptor separation distance to a range smaller than 10 nm [5]. Gueroui and Libchaber [1a] made a QD-NP ensemble, and confirmed that the energy transfer between QD and NP can be described by Equation (1), where R₀ was 7.5 nm for their case. It is believed that the transient dipole of the CdSe QD induced a dipole in the metallic particle. These two dipoles interacted within the distance ranging from 5 to 10 nm. This leads to an energy transfer.

In the case that one donor can interact with several acceptors brought in close proximity simultaneously, Equation (1) can be modified to account for the presence of these complex interactions, and therefore the FRET efficiency can be given by [5]:

$$E = \frac{n {R}_{0}^{6}}{n {R}_{0}^{6} + r} \qquad ( 2 )$$

where n is the average number of acceptors interacting with one donor. In the present embodiment one QD is quenched by several metallic NPs in order to improve the energy transfer efficiency. The number of metallic NPs can be adjusted by the concentration of DNA strands on a QD, which is determined by synthesis of DNA-conjugated QDs.

The distance between the QD and the NP can be controlled by changing the DNA sequence length so that the energy flow from the QD to the NP can be ensured. The DNA double helix is formed from the Watson-Crick Model through complementary base pairs (A-T, C-G) by H-bonding. Therefore, the average distance between the DNA base pairs is 0.34 nm in the double helical structures. An efficient number of base pairs are significant for the formation of stable DNA helix. In this application stable means able to overcome the energy competition factor, such as H-bonding with water. Theoretically a longer the DNA chain will result in a more stable double helix formation if the two strands are complementary. A complete DNA-helix cycle with a major groove and a minor groove usually involves 11 to 13 residues. It is generally believed that a stable helix will be formed when 15 or more complementary DNA base pairs are employed. However, length of the double helical DNA directly influences the distance between the QD and the NP. The distance is crucial for the fluorescent quenching. The efficient fluorescent quenching of QD by NP requires the distance of less than 10 nm. A shorter distance gives higher quenching efficiency.

DNA sequences with 11-25 residues can allow the FRET to occur and still be effective in providing stability. For instance, a short DNA sequence within the range of 14-17 residues may be used in the formation of the nanoparticle assembly in order to balance the two competing factors. As an example, the distance between a DNA 5′-terminal to 3′-terminal for a 15 residue strand is less than 6 nm. 6 nm is within the distance needed to allow the efficient fluorescent quenching of the QD by the NPs.

An embodiment of the biosensor can be applied to measure real-world samples including river water and drinking water. A single biosensor assay containing M²⁺ nanoprobes can be spiked with the real-world water sample to perform real time measurements. A target real-world sample may contain other active organic compound or biological molecules that potentially interact with either metal cations or DNA nucleosides. Therefore, if needed, the real-world water sample can be pretreated prior to measurement. Pretreatment may be any option known to one skilled within the art to pretreat an assay to eliminate interference with the heavy metals or the DNA nucleosides. One such treatment is filtering the sample through Whatman No. 1 paper and then treating with 4:1 HNO₃:HCl at 150° C. to remove organic matrixes. Subsequently the sample can be diluted with deionized water, followed by neutralization with NaHCO₃ solution to pH 7. The pretreatment would not only eliminate the interference of the organic compounds but also convert organometallic compounds to literal heavy-metal ions.

In another embodiment the optical assay can be used together with a portable handheld spectrofluorometer to achieve on-site, real-time monitoring of heavy metal pollutants. Heavy metal toxicity in association with the long residence time within food chains, and the potential for human exposure makes it necessary to monitor heavy metal concentrations in aquatic and terrestrial ecosystems. This embodiment offers the capability of accurate and rapid detection of multiple heavy metals simultaneously. The detection can be used to periodically monitor the quality of water for drinking, industrial and agricultural applications. Ultimately, the knowledge obtained can be used in order to will reduce the risk of environmental exposure to heavy metal pollutants.

These terms and specifications, including the examples, serve to describe the invention by example and not to limit the invention. It is expected that others will perceive differences, which, while differing from the forgoing, do not depart from the scope of the invention herein described and claimed. In particular, any of the function elements described herein may be replaced by any other known element having an equivalent function.

### REFERENCES

1 (a). Z. Gueroui, A. Libchaber, Single-molecule measurements of gold-quenched quantum dots, Phys. Rev. Lett., 93, (2004), 166108; (b). L. Dyadyusha, H. Yin, S. Jaiswal, T. Brown, J. J. Baumberg, F. P. Booy, T. Melvin, Quenching of CdSe quantum dot emission, a new approach for biosensing, Chem. Commun., 25, (2005), 3201-3203; (c). E. Chang, J. S. Miller, J. Sun, W. W. Yu, V. L. Colvin, R. Drezek, J. L. West, Protease-activated quantum dot probes, Biochemical and Biophysical Research Communications., 334, (2005), 1317-1321.
2. A. Ono, H. Togashi, Highly selective oligonucleotide-based sensor for mercury (II) in aqueous solutions, Angew. Chem. Int. Ed., 43, (2004), 4300-4302
3. K. Tanaka, G. H. Clever, Y. Takezawa, Y. Yamada, C. Kaul, M. Shionoya, T. Carell, Programmable self-assembly of metal ions inside artificial DNA duplexes, Nature Nanotechnology., 1, (2006), 190-194
4. J. R. Lakowicz, Principles of Fluorescence Spectroscopy, Plenum Publishing Corporation, 2nd edition, New York, (Jul. 1, 1999).
5. A. R. Clapp, I. L. Medintz, J. M. Mauro, B. R. Fisher, M. G. Bawendi, Fluorescence resonance energy transfer between quantum dot donors and dye-labeled protein acceptors. J. Am. Chem. Soc., 126, (2004), 301-310.

What is claimed is:

1. A heavy metal detection sensor comprising one or more quantum dots capable of generating a fluorescent resonance energy transfer which can be quenched by donating energy to one or more metallic nanoparticles in close proximity wherein said quantum dots and said nanoparticles are further comprised of non-complementary ssDNA molecular recognition probes covalently attached wherein said ssDNA molecular recognition probes on said quantum dots and said nanoparticles are capable of hybridization in the presence of one or more specific heavy metals so as to create said close proximity between said quantum dots and said nanoparticles.

2. The heavy metal detection sensor of claim 1 wherein the metallic nanoparticle is chosen from one or more of Au, Ag, or Pt.

3. The heavy metal detection sensor of claim 1 wherein said molecular recognition probe length is about 11 to about 25 nucleotides.

4. The heavy metal detection sensor of claim 3 wherein one or more of said molecular recognition probes of the quantum dot and metallic nanoprobe contain a thymine-thymine mismatch.

5. The heavy metal detection sensor of claim 3 wherein one or more of said molecular recognition probes of the quantum dot and metallic nanoprobe contain a non-natural nucleobase hydroxypridone.

6. The heavy metal detection sensor of claim 3 wherein one or more of said molecular recognition probes of the quantum dot and metallic nanoprobe contain a guanine rich region.

7. The heavy metal detection sensor of claim 6 wherein said quantum dots and said metallic nanoprobes each contain two covalently bonded molecular recognition probes.

8. The heavy metal detection sensor of claim 4 wherein the specific heavy metal is Hg²⁺.

9. The heavy metal detection sensor of claim 5 wherein the specific heavy metal is Cu²⁺.

10. The heavy metal detection sensor of claim 7 wherein the specific heavy metal is Pb²⁺.

11. The heavy metal detection sensor of claim 3 wherein one or more of said molecular recognition probes of the quantum dot and metallic nanoprobe contain one or more of a thymine-thymine mismatch, a non-natural nucleobase hydroxyprione, and a guanine rich region.

12. The heavy metal detection sensor of claim 11 wherein the specific heavy metal is one or more of Hg²⁺, Cu²⁺, and Pb²⁺.

13. The heavy metal detection sensor of claim 3 wherein said quantum dots contains one or more colored a wavelengths of about 380 nanometers to about 25 microns and said metallic nanoparticles contain one or more colored a wavelengths of about 380 nanometers to about 25 microns.

14. The heavy metal detection sensor of claim 13 further comprising a ultraviolet source to excite said quantum dots.

15. A heavy metal detection assay comprising a sufficient amount of metallic nanoparticles, quantum dots, and a buffer solution wherein said metallic nanoparticles and said quantum dots are further comprised of a shell containing one or more colored wavelengths of about 380 nanometers to about 25 microns and are capable of generating a fluorescent resonance energy transfer which can be quenched when said quantum dots in close proximity with said nanoparticles, said quantum dots and said nanoparticles further comprising non-complementary ssDNA molecular recognition probes capable of hybridization in the presence of a specific heavy metal causing said close proximity wherein said quenching can be observed when said assay is kept at a sufficient temperature and said quantum dots are excited by a light source.

16. The heavy metal detection assay of claim 15 wherein one or more of said molecular recognition probes contain one or more of a thymine-thymine mismatch, a non-natural nucleobase hydroxypridone, and guanine rich region for selection of one or more of the specific heavy metals Hg²⁺, Cu²⁺, and Pb²⁺.

17. The heavy metal detection assay of claim 15 further comprising the use of an ultraviolet laser source to excite said quantum dots.

18. The heavy metal detection assay of claim 15 further comprising a pretreatment of a sample for heavy metal detection.

19. The heavy metal detection assay of claim 15 further comprising the use of an optical assay and a spectrofluorometer for the detection in said assay.

20. The heavy metal detection assay of claim 15 wherein said shell is a CdSe/ZnS core-shell.
